(19) United States
(12) Patent Application Publication
(10) Pub. No.: US 2025/0028046 A1
(43) Pub. Date: Jan. 23, 2025

(54) METHOD AND APPARATUS FOR DETECTING LIGHT SOURCE

(71) Applicant: HYUNDAI MOBIS CO., LTD., Seoul (KR)

(72) Inventors: Moon Yong JIN, Yongin-si (KR); Jun Ho CHOI, Uiwang-si (KR)

(73) Assignee: HYUNDAI MOBIS CO., LTD., Seoul (KR)

(21) Appl. No.: 18/429,834

(22) Filed: Feb. 1, 2024

(30) Foreign Application Priority Data
Jul. 18, 2023 (KR) 10-2023-0093027

(51) Int. Cl. G01S 17/46; G01S 17/89; G06V 20/00; G06V 20/56

(52) U.S. Cl. CPC G01S 17/46; G01S 17/89; G06V 20/38; G06V 20/56

(57) ABSTRACT

An apparatus and method of detecting a position of a light source are provided. The method includes: generating a top view image of a vehicle by using one or more cameras mounted on the vehicle; detecting a shadow area from the top view image by using an artificial intelligence model trained to recognize objects from a video or an image input; detecting a first area corresponding to an area of a shadow of the vehicle from the shadow area; detecting a direction of the light source based on the first area; and calculating an incidence angle at which light emitted from the light source is incident on the vehicle, based on the first area.

### CROSS-REFERENCE TO RELATED APPLICATION(S)

The present application claims priority to and the benefit under 35 USC § 119 of Korean Patent Application No. 10-2023-0093027, filed on Jul. 18, 2023, in the Korean Intellectual Property Office, the entire disclosure of which is incorporated herein by reference for all purposes.

### BACKGROUND

### 1. Field of the Invention

The present disclosure relates to a method and apparatus for detecting a light source, and more particularly, to a method and apparatus for detecting a light source present at a distance.

### 2. Description of Related Art

The content described in the present section simply provides background information for the present disclosure and does not constitute related art.

A technology for detecting a light source in a vehicle is one of essential technologies for a future vehicle. For example, when a light source is detected, internal lightings of a vehicle may be adjusted depending on a position of the light source, or an internal temperature of the vehicle may be controlled depending on the intensity of light. Alternatively, a light source may be detected and a charging system for a solar cell mounted on a vehicle may be efficiently utilized. Alternatively, a tinting technology for detecting a light source and adjusting an amount of light incident on the inside of the vehicle may be applied.

In the related art, a light source is not detected by a vehicle, or the light source is detected depending on whether brightness in a video captured by a camera mounted on the vehicle exceeds a preset threshold. According to a light source detection method and apparatus of the related art, a video is divided into pixels, a brightness value of each pixel is calculated, and a determination as to whether the brightness value of each pixel exceeds a threshold is performed to detect a position of a light source. According to the light source detection method and apparatus of the related art, a shape of a shadow of the vehicle generated by the light source is analyzed and a determination as to whether the light source is a point light source or a directional light source is performed. Here, the point light source is a light source whose size is so small that the size is ignored, and light emitted from the point light source is emitted uniformly in all directions. On the other hand, the directional light source is larger in size than the point light source, and a direction of light emitted from the directional light source is limited.

The light source detection method and apparatus of the related art have several problems. Since the light source detection method and apparatus of the related art directly detect a light source by using a threshold of the brightness of each pixel in a video, the light source detection method and apparatus of the related art may detect the light source only when the light source is included in the video. When the video is captured by using a surround view camera, the light source detection method and apparatus can only detect light sources present in a short-distance area. Accordingly, the light source detection method and apparatus of the related art also have a problem in that the light source detection method and apparatus cannot detect a light source present at a distance, such as the sun.

### SUMMARY

In the view of the above, the present disclosure is intended to solve these problems, and a main object of the present disclosure is to detect a light source present at a distance, such as the sun.

Further, another main object of the present disclosure is to implement a cost-effective method and apparatus for detecting a light source by providing a method and apparatus for detecting the light source using only an apparatus mounted on an existing vehicle.

The problems to be solved by the present disclosure are not limited to the problems mentioned above, and other problems not mentioned can be clearly understood by those skilled in the art from the description below.

This Summary is provided to introduce a selection of concepts in simplified form that are further described below in the Detailed Description. This Summary is not intended to identify key features or essential features of the claimed subject matter, nor is it intended to be used as an aid in determining the scope of the claimed subject matter.

In a general aspect of the disclosure, a method of detecting a position of a light source includes: generating a top view image of a vehicle by using one or more cameras mounted on the vehicle; detecting a shadow area from the top view image by using an artificial intelligence model trained to recognize objects from a video or an image input; detecting a first area corresponding to an area of a shadow of the vehicle from the shadow area; detecting a direction of the light source based on the first area; and calculating an incidence angle at which light emitted from the light source is incident on the vehicle, based on the first area.

The one or more cameras may include a surround view camera.

The method may further include: generating a second area bordered by a straight line and an outline of the first area, wherein the straight line is a line which connecting both end points of a tangent line between the first area and the vehicle area; generating a first straight line by connecting a center of the second area to a center of the area of the vehicle; detecting a first point and a second point, wherein the first point is a contact point between the first straight line and the area of the vehicle, and the second point is a contact point between an extension of the first straight line and an outline of the second area; generating a second straight line by connecting the first point and the second point; and calculating the incidence angle at which the light emitted from the light source is incident, by using the second straight line and the height of the vehicle.

The method may further include determining whether a current time is daytime and the vehicle is located outdoors, and detecting the shadow area from the top view image, if the current time is daytime and the vehicle is located outdoors.

The method may further include determining whether the vehicle is located outdoors may be determined by using an illuminance sensor.

In another general aspect of the disclosure, a method of detecting an intensity of a light source includes: generating a top view image of a vehicle by using one or more cameras mounted on the vehicle; detecting a shadow area from the top view image by using an artificial intelligence model trained to recognize objects from a video or an image input; calculating a first brightness that is an average brightness of the shadow area; calculating a second brightness that is an average brightness of remaining areas other than the shadow area in the top view image; and detecting the intensity of the light source using a difference between the first brightness and the second brightness.

The method may further include detecting a first area corresponding to an area of a shadow of the vehicle from the shadow area, detecting a direction of the light source based on the first area; and calculating an incidence angle at which light emitted from the light source is incident on the vehicle, based on the first area.

In yet another general aspect of the disclosure, a light source detection apparatus includes: a sensor including an illuminance sensor and one or more cameras; a top view image generator configured to generate a top view image of a vehicle from a captured image from the one or more cameras; an object separator configured to detect a shadow area from the top view image by using an artificial intelligence model trained to recognize objects from a video or an image input; and a light source detector configured to detect a position and intensity of a light source based on the shadow area.

The one or more cameras may include a surround view camera.

If the current time is daytime, the object separator may be further configured to: determine whether a current time is daytime; and detect the shadow area from the top view image.

If the vehicle is located outdoors, the object separator may be further configured to: determine whether the vehicle is located outdoors using a measured illuminance value from the illuminance sensor; and detect the shadow area from the top view image.

The light source detection apparatus may further include one or more processors configured to control the top view image generator, the object separator, and the light source detector.

The one or more processors may be further configured to: calculate a first brightness that is an average brightness of the shadow area; calculate a second brightness that is an average brightness of remaining areas other than the shadow area in the top view image; and detect the intensity of the light source using a difference between the first brightness and the second brightness.

As described above, according to the various aspects of the disclosure it is possible to detect a light source present at a distance, such as the sun.

Further, according to various aspects of the disclosure, it is possible to implement a cost-effective method and apparatus for detecting a light source by providing a method and apparatus for detecting the light source using only an apparatus mounted on an existing vehicle.

### BRIEF DESCRIPTION OF THE DRAWINGS

FIG. 1 is a block diagram of a light source detection apparatus according to an embodiment of the present disclosure.

FIG. 2 is a flowchart illustrating a method of detecting a light source according to an embodiment of the present disclosure.

FIGS. 3A to 3D are diagrams illustrating a process of detecting a first area according to an embodiment of the present disclosure.

FIG. 4 is a flowchart illustrating a method of detecting a position of a light source according to an embodiment of the present disclosure.

FIG. 5 is a flowchart illustrating S450 of FIG. 4 in detail.

FIGS. 6A to 6C are diagrams illustrating a process for calculating a direction of the light source and an incidence angle of light according to an embodiment of the present disclosure.

FIG. 7 is a flowchart illustrating a method of detecting the intensity of the light source according to an embodiment of the present disclosure.

### DETAILED DESCRIPTION

Hereinafter, some exemplary embodiments of the present disclosure will be described in detail with reference to the accompanying drawings. In the following description, like reference numerals preferably designate like elements, although the elements are shown in different drawings. Further, in the following description of some embodiments, a detailed description of known functions and configurations incorporated therein will be omitted for the purpose of clarity and for brevity.

Additionally, various terms such as first, second, A, B, (a), (b), etc., are used solely to differentiate one component from the other but not to imply or suggest the substances, order, or sequence of the components.

When a component is described as being ‘linked,’ ‘coupled,’ or ‘connected’ to another component, it should be understood that the component may be directly linked or connected to the other component, and that yet another component may be ‘linked,’ ‘coupled,’ or ‘connected’ between each component.

Throughout the present specification, when a part ‘includes’ or ‘comprises’ a component, the part is meant to further include other components, not to exclude thereof unless specifically stated to the contrary.

The terms such as ‘unit’, ‘module’, and the like refer to one or more units for processing at least one function or operation, which may be implemented by hardware, software, or a combination thereof.

Unless otherwise noted, the description of one embodiment is intended to be applicable to other embodiments.

The following detailed description, together with the accompanying drawings, is intended to describe exemplary embodiments of the present invention and is not intended to represent the only embodiments in which the present invention may be practiced.

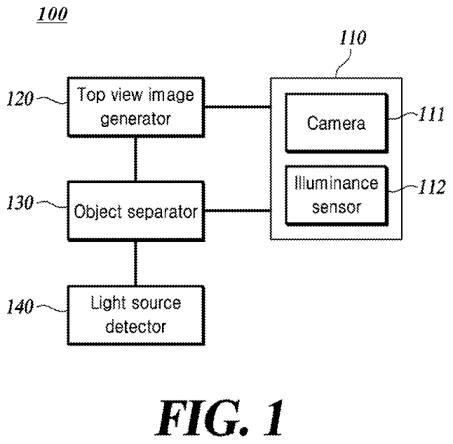

FIG. 1 is a block diagram of a light source detection apparatus according to an embodiment of the present disclosure.

Referring to FIG. 1, the light source detection apparatus 100 according to an embodiment of the present disclosure may include all or some of a sensor unit 110, a top view image generator 120, an object separator 130, and a light source detector 140.

The sensor unit 110 may include an illuminance sensor 112 and at least one camera 111.

The illuminance sensor 112 may be a photo-diode, a photo-transistor, a photo-capacitor, or a photo-detector. The illuminance sensor 112 may be mounted on at least part of the vehicle. For example, the illuminance sensor 112 may be mounted on a dashboard or windshield of the vehicle.

The camera 111 may be a surround view camera. The camera 111 may be mounted on at least part of the vehicle. For example, the camera 111 may be mounted on front, rear, left, and right sides of the vehicle to photograph surroundings of the vehicle so that blind spots do not occur.

The top view image generator 120 may receive data for captured videos from the camera 111 and generate a top view image by combining the received videos. In the present disclosure, the top view image is an image viewed from vertical top to bottom of the vehicle, with the vehicle set at a center. The top view image generator 120 may generate the top view image using an artificial intelligence model (AI). For example, the top view image generator 120 may generate the top view image by inputting the captured video from the camera 111 to the artificial intelligence model. Here, the artificial intelligence model may be trained to receive videos captured from a plurality of angles and generate a top view image.

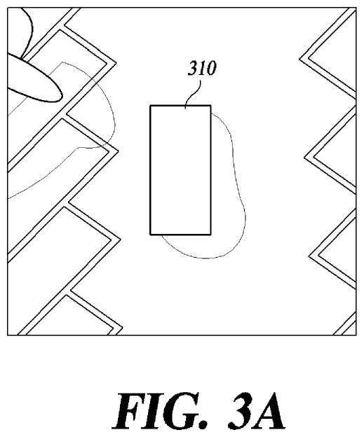

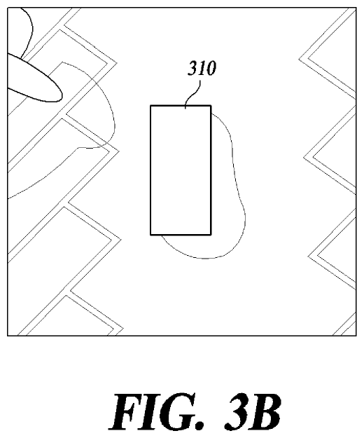

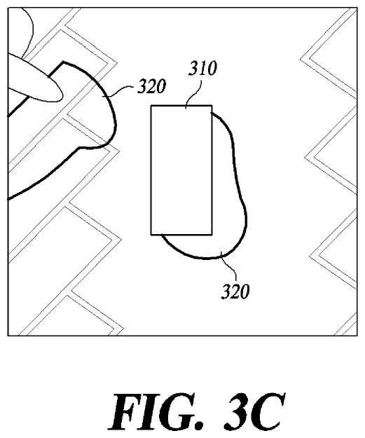

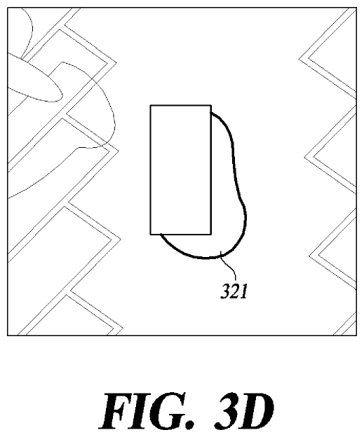

The object separator 130 may include an artificial intelligence model trained to recognize objects. The word ‘objects’ include an areas of shadow of the objects. Here, it should be noted that the artificial intelligence model is different from the artificial intelligence model that generates the top view image. Hereinafter, the artificial intelligence model is an artificial intelligence model trained to recognize objects from a video or an image input. The artificial intelligence model may be YOLO (You Only Look Once), CNN (Convolutional Neural Network), SSD (Single Shot multibox Detector), RetinaNet, or the like. The object separator 130 may detect a first area 321 from the top view image using the artificial intelligence model trained to recognize objects. A process in which the object separator 130 detects the first area 321 from the top view image using the artificial intelligence model will be described in detail later with reference to FIGS. 3A to 3D.

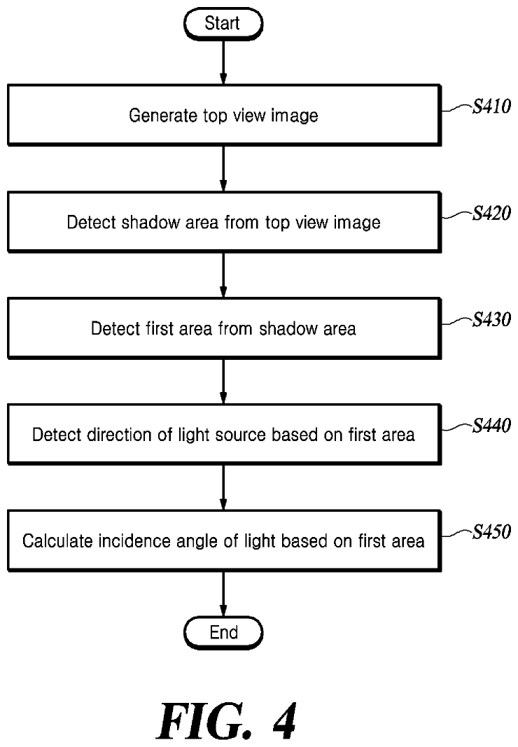

The light source detector 140 may receive data for the first area 321 from the object separator 130 and detect a position and intensity of the light source based on the data for the first area 321. A process in which the light source detector 140 detects the position and intensity of the light source will be described in detail later with reference to FIGS. 4 to 7.

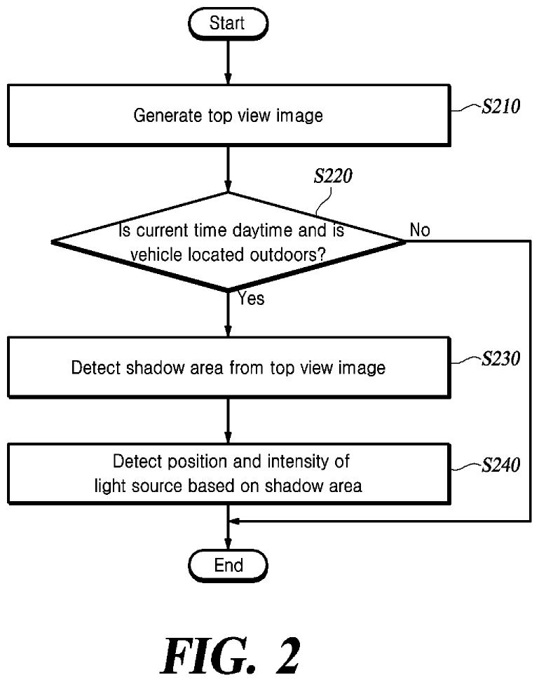

FIG. 2 is a flowchart illustrating a method of detecting a light source according to an embodiment of the present disclosure.

Referring to FIG. 2, a method of detecting a light source according to an embodiment of the present disclosure may be a method of detecting the sun. The method of detecting a light source according to an embodiment of the present disclosure may include determining whether the sun is currently above a horizon in order to detect the sun. Accordingly, the method of detecting a light source according to an embodiment of the present disclosure is as follows.

The light source detection apparatus 100 may generate the top view image (S210). Since a process of generating the top view image may be the same as that described above, description thereof will be omitted.

The light source detection apparatus 100 may determine whether the current time is daytime and the vehicle is located outdoors (S220). Whether the current time is daytime may be determined using an apparatus that includes current space-time information of an electric control unit (ECU), a navigation, or the like mounted on the vehicle. For example, current space-time information may be received from the apparatus including the current space-time information by using a controller area network (CAN), and then, a determination may be performed as to whether the sun is present on a horizon in a current space-time from current date, current time, and current position information. Whether the vehicle is located outdoors may be determined using the illuminance sensor 112. For example, when the brightness measured by the illuminance sensor 112 exceeds a preset threshold, the vehicle is determined to be present outdoors, and when the brightness measured by the illuminance sensor 112 is equal to or lower than the preset threshold, the vehicle is determined to be present indoors.

When the light source detection apparatus 100 determines that the current time is not daytime or that the vehicle is not located outdoors, an algorithm ends. On the other hand, when the light source detection apparatus 100 determines that the current time is daytime and the vehicle is located outdoors, the light source detection apparatus 100 may detect a shadow area 320 from the top view image (S230).

The light source detection apparatus 100 may detect the position and intensity of the light source based on the shadow area 320 (S240).

In the method of detecting a light source according to an embodiment of the present disclosure, a determination is made as to whether the sun is floating in a current space and time, and a light source detection algorithm is executed when the sun is present above the horizon in the current space and time, thereby reducing a power load of the light source detection apparatus 100. The method of detecting a light source according to an embodiment of the present disclosure has an advantage that it is not necessary to mount an additional apparatus by determining whether there is the sun using an illuminance sensor already mounted on the vehicle.

FIGS. 3A to 3D are diagrams illustrating a process of detecting the first area according to an embodiment of the present disclosure. In detail, FIG. 3A is a diagram illustrating the top view image. FIG. 3B is a diagram illustrating a state in which the free space is detected from the top view image. FIG. 3C is a diagram illustrating a state in which the shadow area is detected from the free space. FIG. 3D is a diagram illustrating a state in which the first area is detected in the shadow area.

Referring to FIGS. 3A to 3D, a process in which the light source detection apparatus 100 according to the present disclosure detects the first area is as follows.

The top view image is input to the artificial intelligence model. The top view image may include a vehicle area 310. Here, the vehicle area 310 is an area of the vehicle that serves as a reference for a center of the top view image. The artificial intelligence model detects a free space from the top view image. Here, the free space is a space in which no object is recognized in a video. For example, the free space may be a space in which no buildings, creatures, or other objects are present in a video. The vehicle area 310 may be set in the process of generating the top view image or may be set in a process of recognizing the free space. The artificial intelligence model detects the shadow area 320 in the free space. The artificial intelligence model detects the first area 321 in the shadow area 320. Here, it should be noted that the first area 321 is the shadow area of the vehicle, and the shadow area of the vehicle is not a shadow area of another vehicle included in the top view image.

Artificial intelligence trained to recognize objects is trained using a large amount of data. The artificial intelligence trained to recognize the objects requires a large amount of computation to recognize objects. Therefore, a high-performance computer is required to install the artificial intelligence trained to recognize the objects. On the other hand, since the artificial intelligence model according to the present disclosure does not require a variety of detailed object recognition performance and requires only detection of the shadow area 320 in the free space, a high-performance computer is not required. Accordingly, the object separator or the artificial intelligence model according to the present disclosure may be installed as part of an ECU mounted on the vehicle. Accordingly, the light source detection method and apparatus according to the present disclosure may be provided cost-effectively.

FIG. 4 is a flowchart illustrating a method of detecting the position of the light source according to an embodiment of the present disclosure.

Referring to FIG. 4, the method of detecting the position of the light source according to an embodiment of the present disclosure is as follows.

The light source detection apparatus 100 may generate the top view image (S410). The light source detection apparatus 100 may detect the shadow area 320 from the top view image (S420). The light source detection apparatus 100 may detect the first area from the shadow area 320 (S430). Since a process in which the light source detection apparatus 100 generates the top view image and detects the first area 321 from the top view image may be the same as one described above, description thereof will be omitted.

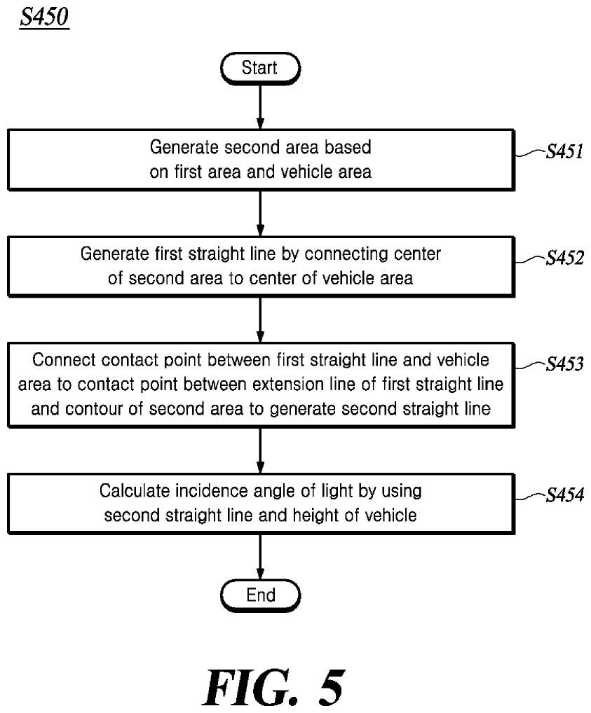

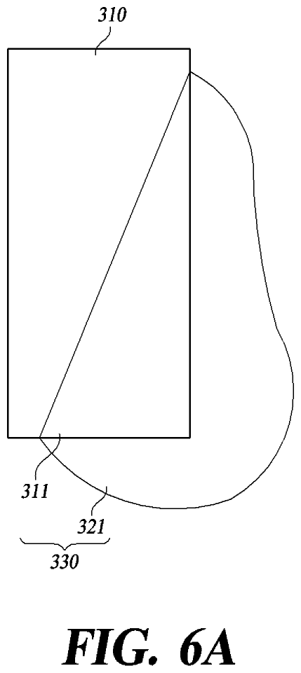

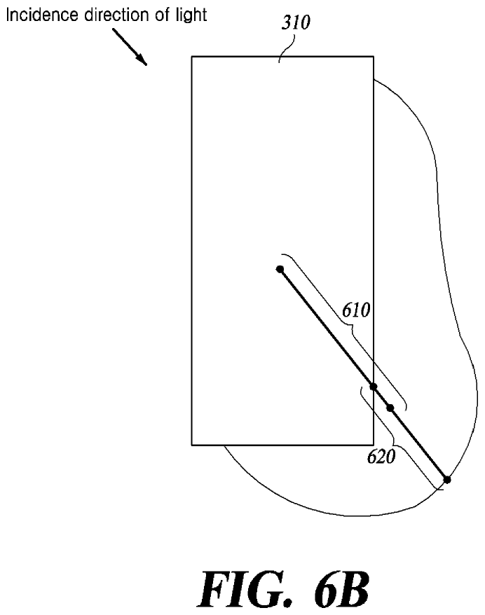

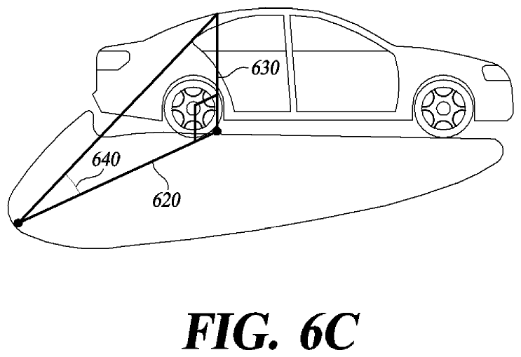

The light source detection apparatus 100 may detect a direction of the light source based on the first area (S440). The light source detection apparatus 100 may calculate an incidence angle 640 at which light emitted from the light source is incident on the vehicle based on the first area (S450). A process in which the light source detection apparatus 100 detects the direction of the light source based on the first area and calculates the incidence angle 640 of the light will be described later with reference to FIGS. 5 to 6C.

FIG. 5 is a flowchart illustrating S450 of FIG. 4 in detail.

FIGS. 6A to 6C are diagrams illustrating a process for calculating the direction of the light source and the incidence angle of the light according to an embodiment of the present disclosure.

Referring to FIGS. 5 to 6C, a process of calculating the direction of the light source and the incidence angle 640 of the light according to an embodiment of the present disclosure is as follows.

The light source detection apparatus 100 may generate a second area 330 based on the first area 321 and the vehicle area 310 (S451). The second area 330 may be generated by connecting both end points of a tangent line between the first area 321 and the vehicle area 310. More specifically, the second area 330 is bordered by a straight line and an outline of the first area 321, wherein the straight line is a line which connecting both end points of a tangent line between the first area 321 and the vehicle area 310. For example, as can be seen in FIG. 6A, the tangent line between the first area 321 and the vehicle area 310 may be the same as a left-right inversion of an “L” shape. When the both end points of the tangent line are connected to each other, a closed area 311 may be generated by the vehicle area 310 and the tangent line. The second area 330 may be generated by adding the closed area 311 to the first area 321. On the other hand, when the vehicle area 310 is not a square, the tangent line between the first area 321 and the vehicle area 310 may be curved. Even when the tangent line between the first area 321 and the vehicle area 310 is curved, the second area 330 can be generated by connecting both end points of the tangent line, as described above.

The light source detection apparatus 100 may generate a first straight line 610 by connecting a center of the second area 330 to a center of the vehicle area 310 (S452). Here, a determination may be made that the direction of the light source is an opposite direction of the first area with reference to the vehicle area 310 and is on the first straight line 610. The center of the vehicle area 310 may be detected by receiving previously input data from the ECU. However, a method of detecting the center of the vehicle area 310 is not limited to the above-described one. For example, the center of the vehicle area 310 may be detected by dividing the vehicle area 310 into pixels at regular intervals using the light source detection apparatus 100, and then, using coordinate values of a plurality of pixels. The center of the second area 330 may be detected by dividing the second area 330 into pixels at regular intervals using the light source detection apparatus 100, and then, using coordinate values of a plurality of pixels.

The light source detection apparatus 100 may detect a contact point between the first straight line 610 and the vehicle area 310, detect a contact point between an extension line of the first straight line 610 and a contour of the second area 330, and connect the two contact points to generate a second straight line 620 (S453). In other words, the light source detection apparatus 100 may detect a first point and a second point, and then the light source detection apparatus 100 may generate the second straight line 620. The first point is a contact point between the first straight line 610 and the area of the vehicle 310, and the second point is a contact point between an extension of the first straight line 610 and an outline of the second area 330. The light source detection apparatus 100 may calculate the incidence angle 640 at which the light emitted from the light source is incident on the vehicle by using the second straight line 620 and a height 630 of the vehicle (S454). For example, the incidence angle 640 of the light may be calculated by using Equation 1.

$$α = {tan}^{- 1} ( \frac{y}{x} ) \qquad [ Equation 1 ]$$

In Equation 1, α denotes an incidence angle 640 of the light, x denotes a length of the second straight line 620, and y denotes a height 630 of the vehicle. Here, previously input data may be received from the ECU and the height 630 of the vehicle may be detected. For example, the ECU may provide the light source detection apparatus 100 with data for the height of the vehicle with reference to the contact point between the first straight line 610 and the vehicle area 310.

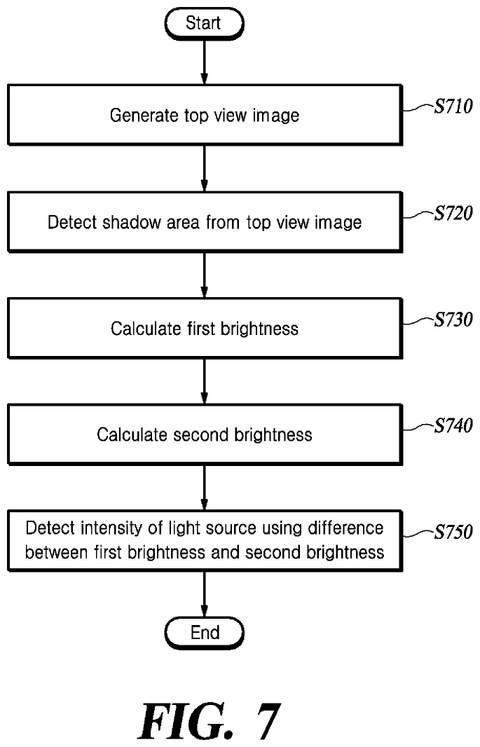

FIG. 7 is a flowchart illustrating a method of detecting the intensity of the light source according to an embodiment of the present disclosure.

Referring to FIG. 7, a process of detecting the intensity of a light source according to an embodiment of the present disclosure is as follows.

The light source detection apparatus 100 may generate the top view image (S710). The light source detection apparatus 100 may detect the shadow area 320 from the top view image (S720). Since a process in which the light source detection apparatus 100 generates the top view image and detects the shadow area 320 from the top view image may be the same as that described above, description thereof will be omitted.

The light source detection apparatus 100 may calculate first brightness (S730). Here, the first brightness is average brightness of the shadow area 320. The light source detection apparatus 100 may calculate second brightness (S740). Here, the second brightness is average brightness of a remaining area other than the shadow area. That is, the second brightness is average brightness of an area other than the shadow area in the free space of the top view image.

The process of calculating the first brightness and the second brightness may be as follows. An area of which the brightness is to be calculated is divided into pixels. Brightness of each pixel is measured. Here, the brightness may be measured as an average of values of R, G, and B channels of the pixel. The first brightness and the second brightness are calculated by dividing a sum of the brightness of the respective pixels by the number of pixels in the area of which the brightness is to be measured. Alternatively, the first brightness and the second brightness may be calculated by using various methods. For example, the first brightness and the second brightness may be calculated by using a histogram.

The light source detection apparatus 100 may detect the intensity of the light source using a difference between the first brightness and the second brightness (S750).

The light source detection apparatus 100 or method according to the present disclosure does not require complex calculations and does not require new data for vehicle specification parameters. That is, the light source detection method according to the present disclosure can be implemented by using vehicle specification parameters of a vehicle on which the light source detection apparatus 100 according to the present disclosure is not mounted. Accordingly, the light source detection apparatus 100 or method according to the present disclosure have an advantage that the light source detection apparatus 100 or method can be implemented without an additional apparatus mounted on the vehicle.

Various applications can be created by using the light source detection apparatus 100 or method according to the present disclosure. For example, charging efficiency of the vehicle can be maximized by adjusting an angle of a solar cell such as a solar loop or solar panel mounted on the vehicle depending on the position of the light source and the intensity of the light. Further, it is possible to prevent glare to the driver from occurring and effectively block ultraviolet rays (UV light) by applying an automatic tinting function to a window of the vehicle and adjusting transparency of the window of the vehicle depending on the position of the light source and the intensity of the light.

The flowchart of the present disclosure describes processes as being sequentially executed, but this is merely illustrative of the technical idea of an embodiment of the present disclosure. In other words, since it is apparent to those having ordinary skill in the art that an order described in the flowchart may be changed or one or more processes may be executed in parallel without departing from the essential characteristics of an embodiment of the present disclosure, the flowchart is not limited to a time-series order.

Various implementations of systems and techniques described herein may be realized as digital electronic circuits, integrated circuits, field programmable gate arrays (FPGAs), application specific integrated circuits (ASICs), computer hardware, firmware, software, and/or combinations thereof. These various implementations may include one or more computer programs executable on a programmable system. The programmable system includes at least one programmable processor (which may be a special-purpose processor or a general-purpose processor) coupled to receive and transmit data and instructions from and to a storage system, at least one input device, and at least one output device. The computer programs (also known as programs, software, software applications or codes) contain commands for a programmable processor and are stored in a “computer-readable recording medium”.

The computer-readable recording medium includes all types of recording devices in which data readable by a computer system is stored. Such a computer-readable recording medium may be a non-volatile or non-transitory medium, such as ROM, CD-ROM, magnetic tape, floppy disk, memory card, hard disk, magneto-optical disk, or a storage device, and may further include a transitory medium such as a data transmission medium. In addition, the computer-readable recording medium may be distributed in a computer system connected via a network, so that computer-readable codes may be stored and executed in a distributed manner.

Various implementations of systems and techniques described herein may be embodied by a programmable computer. Here, the computer includes a programmable processor, a data storage system (including volatile memory, non-volatile memory, or other types of storage systems, or combinations thereof) and at least one communication interface. For example, the programmable computer may be one of a server, a network device, a set top box, an embedded device, a computer expansion module, a personal computer, a laptop, a personal data assistant (PDA), a cloud computing system, or a mobile device.

Although exemplary embodiments of the present disclosure have been described for illustrative purposes, those having ordinary skill in the art will appreciate that various modifications, additions, and substitutions are possible, without departing from the idea and scope of the claimed invention. Therefore, exemplary embodiments of the present disclosure have been described for the sake of brevity and clarity. The scope of the technical idea of the present embodiments is not limited by the illustrations. Accordingly, one of ordinary skill would understand that the scope of the claimed invention is not to be limited by the above explicitly described embodiments but by the claims and equivalents thereof.

What is claimed is:

1. A method of detecting a position of a light source, the method comprising:
generating a top view image of a vehicle by using one or more cameras mounted on the vehicle;
detecting a shadow area from the top view image by using an artificial intelligence model trained to recognize objects from a video or an image input;
detecting a first area corresponding to an area of a shadow of the vehicle from the shadow area;
detecting a direction of the light source based on the first area; and
calculating an incidence angle at which light emitted from the light source is incident on the vehicle, based on the first area.

2. The method of claim 1, wherein the one or more cameras includes a surround view camera.

3. The method of claim 1, further comprising:
generating a second area bordered by a straight line and an outline of the first area, wherein the straight line is a line which connecting both end points of a tangent line between the first area and the vehicle area;
generating a first straight line by connecting a center of the second area to a center of the area of the vehicle;
detecting a first point and a second point, wherein the first point is a contact point between the first straight line and the area of the vehicle, and the second point is a contact point between an extension of the first straight line and an outline of the second area;
generating a second straight line by connecting the first point and the second point; and
calculating the incidence angle at which the light emitted from the light source is incident, by using the second straight line and the height of the vehicle.

4. The method of claim 1, further comprising:
determining whether a current time is daytime and the vehicle is located outdoors; and
detecting the shadow area from the top view image, if the current time is daytime and the vehicle is located outdoors.

5. The method of claim 4, further comprising:
determining whether the vehicle is located outdoors by using an illuminance sensor.

6. A method of detecting an intensity of a light source, the method comprising:
generating a top view image of a vehicle by using one or more cameras mounted on the vehicle;
detecting a shadow area from the top view image by using an artificial intelligence model trained to recognize objects from a video or an image input;
calculating a first brightness that is an average brightness of the shadow area;
calculating a second brightness that is an average brightness of remaining areas other than the shadow area in the top view image; and
detecting the intensity of the light source using a difference between the first brightness and the second brightness.

7. The method of claim 6, further comprising:
detecting a first area corresponding to an area of a shadow of the vehicle from the shadow area;
detecting a direction of the light source based on the first area; and
calculating an incidence angle at which light emitted from the light source is incident on the vehicle, based on the first area.

8. A light source detection apparatus comprising:
a sensor including an illuminance sensor and one or more cameras;
a top view image generator configured to generate a top view image of a vehicle from a captured image from the one or more cameras;
an object separator configured to detect a shadow area from the top view image by using an artificial intelligence model trained to recognize objects from a video or an image input; and
a light source detector configured to detect a position and intensity of a light source based on the shadow area.

9. The light source detection apparatus of claim 8, wherein the one or more cameras includes a surround view camera.

10. The light source detection apparatus of claim 8, wherein, if the current time is daytime, the object separator is further configured to:
determine whether a current time is daytime; and
detect the shadow area from the top view image.

11. The light source detection apparatus of claim 8, wherein, if the vehicle is located outdoors, the object separator is further configured to:
determine whether the vehicle is located outdoors using a measured illuminance value from the illuminance sensor; and
detect the shadow area from the top view image.

12. The light source detection apparatus of claim 8, further comprising:
one or more processors configured to control the top view image generator, the object separator, and the light source detector.

13. The light source detection apparatus of claim 12, wherein the one or more processors are further configured to:
calculate a first brightness that is an average brightness of the shadow area;
calculate a second brightness that is an average brightness of remaining areas other than the shadow area in the top view image; and
detect the intensity of the light source using a difference between the first brightness and the second brightness.
